(19) United States
(12) Patent Application Publication
(10) Pub. No.: US 2025/0310952 A1
(43) Pub. Date: Oct. 2, 2025

(54) Sub-Grouping and Configuration of Logical Channel ID Spaces for MAC CEs / SDUs

(71) Applicant: Apple Inc., CUPERTINO, CA (US)

(72) Inventors: Ralf ROSSBACH, Munich (DE); Bobby JOSE, San Diego, CA (US); Murtaza A SHIKARI, Mountain View, CA (US); Fangli XU, Beijing (CN); Pavan NUGGEHALLI, San Carlos, CA (US); Weidong YANG, San Diego, CA (US); Zhanfeng JIA, San Carlos, CA (US); Naveen Kumar R PALLE VENKATA, San Diego, CA (US); Haijing HU, Los Gatos, CA (US); Vijay VENKATARAMAN, San Jose, CA (US); Ralf ITJESHORST, Walpertskirchen (DE); Petr KOSTKA, Munich (DE)

(21) Appl. No.: 18/864,379

(22) PCT Filed: May 9, 2022
(86) PCT No.: PCT/CN2022/091704

§ 371 Date: Nov. 8, 2024

(51) Int. Cl. H04W 72/1263; H04W 72/54; H04W 72/563

(52) U.S. Cl. CPC H04W 72/1263; H04W 72/54; H04W 72/563

(57) ABSTRACT

A medium access control (MAC) layer instance of a user equipment (UE) or a base station is configured to determine to transmit a first MAC control element (MAC CE), construct a MAC sub protocol data unit (sub-PDU) including a MAC sub-header and a payload including the first MAC CE, indicate, in the MAC sub-header, a logical channel identifier (LCID) value that identifies a first group of MAC CEs categorized based on a feature, the first group of MAC CEs including the first MAC CE and map the MAC sub-PDU to a transport block (TB) for transmission on a physical (PHY) layer.

### TECHNICAL FIELD

The present disclosure relates to wireless communication, and in particular, to sub-grouping and configuration of logical channel ID spaces for MAC CEs/SDUs.

### BACKGROUND INFORMATION

The medium access control (MAC) layer of a radio access network (RAN) protocol stack can transmit/receive MAC service data units (SDU), MAC control elements (CE) and/or padding in a MAC sub protocol data unit (sub-PDU). Each MAC sub-PDU includes a MAC sub-header indicating a logical channel identifier (LCID) value identifying the logical channel for the payload, e.g., the MAC SDU or the MAC CE. The LCID field comprises 6 bits and establishes 64 LCID values in the LCID space. In addition, an 8-bit or 16-bit extended LCID (eLCID) field can be added to the MAC sub-header to extend the LCID space. In general, less frequent and/or low priority MAC CEs are assigned to an LCID index in the eLCID space, while more frequent and/or high priority MAC CEs are assigned to an LCID index in the LCID space. Certain legacy MAC CEs defined in earlier 3GPP releases are also defined in the LCID space. The mapping between a LCID/eLCID codepoint and a logical channel or MAC CE is defined in 3GPP specification TS 38.321.

A number of new MAC CEs have been introduced in recent 3GPP releases, and it is anticipated that the number of new MAC CEs will continue to increase in future releases, including Rel-17, Rel-18, etc., of 5G NR and potentially in future wireless standards (e.g., 6G). Additionally, more control functions may be moved from the radio resource control (RRC) domain to the MAC domain, requiring still further new MAC CEs. The current LCID allocation framework may require modification or redesign to accommodate these additional MAC CEs while ensuring performance.

### SUMMARY

Some exemplary embodiments are related to a medium access control (MAC) layer instance configured to perform operations. The operations include determining to transmit a first MAC control element (MAC CE), constructing a MAC sub protocol data unit (sub-PDU) including a MAC sub-header and a payload including the first MAC CE, indicating, in the MAC sub-header, a logical channel identifier (LCID) value that identifies a first group of MAC CEs categorized based on a feature, the first group of MAC CEs including the first MAC CE and mapping the MAC sub-PDU to a transport block (TB) for transmission on a physical (PHY) layer.

Other exemplary embodiments are related to a medium access control (MAC) layer instance configured to perform operations. The operations include determining to transmit a first MAC control element (MAC CE), constructing a MAC sub protocol data unit (sub-PDU) including a MAC sub-header and a payload including the first MAC CE, indicating, in the MAC sub-header, a value of a Reserved (R) bit that identifies a first set of logical channel identifier (LCID) tables or a second set of LCID tables used to determine a logical channel or MAC CE identity from an LCID value included in the MAC sub-header and mapping the MAC sub-PDU to a transport block (TB) for transmission on a physical (PHY) layer.

Still further exemplary embodiments are related to a medium access control (MAC) layer instance configured to perform operations. The operations include determining to transmit a first MAC control element (MAC CE), constructing a MAC sub protocol data unit (sub-PDU) including a MAC sub-header and a payload including the first MAC CE, indicating, in the MAC sub-header, a group identifier (group ID) identifying a first group of MAC CEs in an extended LCID (eLCID) space, the first group of MAC CEs including the first MAC CE and mapping the MAC sub-PDU to a transport block (TB) for transmission on a physical (PHY) layer.

### BRIEF DESCRIPTION OF THE DRAWINGS

FIG. 1a shows an exemplary medium access layer (MAC) sub-header for a MAC sub protocol data unit (sub-PDU) including a variable size MAC control element (CE) payload according to existing specification.

FIG. 1b shows an exemplary MAC sub-header including a third octet and an extended LCID (eLCID) field (8 bits) according to existing specification.

FIG. 1c shows an exemplary MAC sub-header including a fourth octet and an eLCID field (16 bits) according to existing specification.

FIG. 2a shows an exemplary mapping table of logical channel ID (LCID) field codepoints to LCID values for the downlink (DL) (e.g., for the DL-SCH transport channel) according to existing specification.

FIG. 2b shows an exemplary mapping table of extended logical channel ID (eLCID) field codepoints to LCID values for the downlink (DL) (e.g., for the DL-SCH transport channel) according to existing specification.

FIG. 2c shows an exemplary mapping table of logical channel ID (LCID) field codepoints to LCID values for the uplink (UL) (e.g., for the UL-SCH transport channel) according to existing specification.

FIG. 2d shows an exemplary mapping table 230 of extended logical channel ID (eLCID) field codepoints to LCID values for the uplink (UL) (e.g., for the UL-SCH transport channel) according to existing specification.

FIG. 3 shows an exemplary MAC sub-header including a group ID field according to various exemplary embodiments.

FIG. 4a shows a method for MAC CE transmission according to various exemplary embodiments.

FIG. 4b shows a method for MAC CE reception according to various exemplary embodiments.

FIG. 5 shows an exemplary network arrangement according to various exemplary embodiments.

FIG. 6 shows an exemplary user equipment (UE) according to various exemplary embodiments.

FIG. 7 shows an exemplary base station according to various exemplary embodiments.

FIG. 8 shows an exemplary MAC CE container according to various exemplary embodiments.

### DETAILED DESCRIPTION

The exemplary embodiments may be further understood with reference to the following description and the related appended drawings, wherein like elements are provided with the same reference numerals. According to various exemplary embodiments described herein, options are proposed for the grouping and allocation of medium access control (MAC) control elements (MAC CEs) to logical channel identifiers (LCIDs). Depending on the specific LCID space and the place in the LCID space selected to signal a particular MAC CE, certain MAC CEs may need fewer bytes to signal, whereas other MAC CEs use more bytes. By optimizing the allocation of MAC CEs to an LCID space, certain MAC CEs may require fewer header bytes for transmission and/or enable a faster processing path.

In some aspects of the present disclosure, MAC CEs are categorized and grouped according to some feature common to the grouped MAC CEs, e.g., function, latency requirements, priority, and/or other features to be described in detail below. In other aspects of the present disclosure, the MAC sub-header format can be used in its existing form or modified to facilitate the identification and processing of a MAC CE that may have a unique LCID value or may be grouped with other MAC CEs under the same LCID value. In still other aspects of the present disclosure, various options are described for configuring and/or reconfiguring a user equipment (UE) to use a different LCID/eLCID mapping for MAC CEs.

The exemplary embodiments are described with regard to a UE. However, the use of a UE is merely provided for illustrative purposes. The exemplary embodiments may be utilized with any electronic component that is configured with the hardware, software, and/or firmware to exchange information (e.g., control information) and/or data with the network. Therefore, the UE as described herein is used to represent any suitable electronic device.

The exemplary embodiments are also described with regard to a 5G New Radio (NR) radio access network (RAN). However, reference to a 5G NR RAN is merely provided for illustrative purposes. The exemplary embodiments may be utilized with any network implementing MAC layer methodologies similar to those described herein. Therefore, the 5G NR network as described herein may represent any type of network implementing similar functionalities as the 5G NR network.

Layer 1 (L1) generally refers to a physical (PHY) layer of a UE or RAN node (e.g., base station). Layer 2 (L2) generally refers to a medium access (MAC) layer, a radio link control (RLC) layer, and a packet data convergence protocol (PDCP) layer and is considered a higher layer than L1. Layer 3 (L3) generally refers to a radio resource control (RRC) layer and is considered a higher layer than L2.

The RLC layer can transmit an RLC protocol data unit (PDU) to the MAC layer. The RLC PDU is referred to as a MAC service data unit (SDU) at the MAC layer. Instances of the MAC layer can transmit/receive MAC SDUs, MAC control elements (CE) and/or padding in a MAC sub-PDU. The MAC layer adds a sub-header to the MAC SDU to construct a MAC sub-PDU. Each MAC sub-PDU includes a MAC sub-header and a payload. A MAC PDU can include multiple MAC sub-PDUs. Instances of the MAC layer may process requests from, and provide indications to, an instance of RLC via one or more MAC service access points (SAPs). These requests and indications communicated via the MAC-SAP may comprise one or more logical channels. The MAC may perform mapping between the logical channels and transport channels, multiplexing of MAC SDUs from one or more logical channels onto transport blocks (TBs) to be delivered to PHY via the transport channels, de-multiplexing MAC SDUs to one or more logical channels from TBs delivered from the PHY via transport channels, multiplexing MAC SDUs onto transport blocks (TBs), scheduling information reporting, error correction through HARQ, and logical channel prioritization (LCP). LCP generally relates to the priority of certain MAC CEs and logical channels when filling a MAC PDU.

The size of the MAC SDU can vary, and the size of some MAC CEs is fixed while other MAC CEs have a variable size. MAC sub-headers, SDUs and CEs are arranged in octets. The MAC sub-header has a first defined format for variable size MAC CEs and MAC SDUs not containing UL common control channel (CCCH), and other defined formats for fixed size MAC CEs, padding, and MAC SDUs containing UL CCCH.

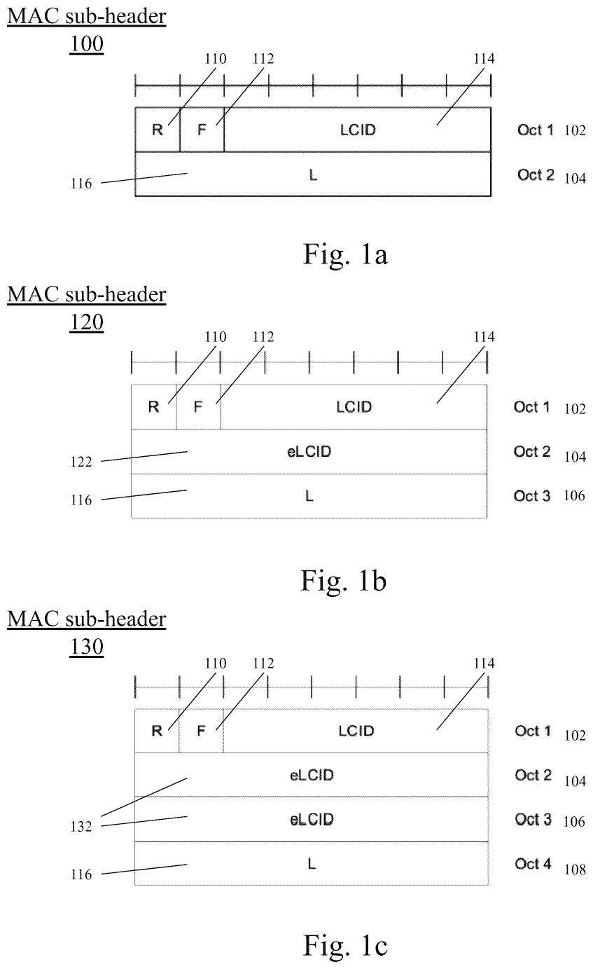

FIG. 1a shows an exemplary medium access layer (MAC) sub-header 100 for a MAC sub protocol data unit (sub-PDU) including a variable size MAC control element (CE) payload according to existing specification. A first octet 102 includes a reserved field R 110 (1 bit), a format field F 112 (1 bit) and a LCID field 114 (6 bits). A second octet 104 includes a length field L 116 (8 bits). A third octet (not shown) can include an additional 8 bits for the L field 116 (16 bits total). In existing specification, the R field 110 is set to 0. The F field 112 can include a 0 indicating L is 8 bits or a 1 indicating L is 16 bits. The L field 116 is not used for fixed size MAC CEs. The L field 116 indicates the length of the payload (e.g., MAC SDU or variable size MAC CE). The LCID field 114 identifies the logical channel for a MAC sub-PDU or a MAC CE. The values of the LCID field 114 have different meanings for DL transmissions and UL transmissions.

LCID spaces for both DL and UL MAC CEs have been extended from Rel-15 to Rel-16 and from Rel-16 to Rel-17. To extend the LCID spaces for MAC CEs, a new MAC sub-header with a one-octet extended LCID (eLCID) field was introduced. FIG. 1b shows an exemplary MAC sub-header 120 including a third octet 106 and an extended LCID (eLCID) field 122 (8 bits) according to existing specification. Additionally, a new MAC sub-header with a two-octet eLCID field was introduced. FIG. 1c shows an exemplary MAC sub-header 130 including a fourth octet 108 and an eLCID field 132 (16 bits) according to existing specification. Currently, the two-octet eLCID field 132 of the MAC sub-header 130 is used only for integrated access and backhaul (IAB) communications. The mapping between a LCID/eLCID codepoint and a logical channel or MAC CE is defined in 3GPP specification TS 38.321.

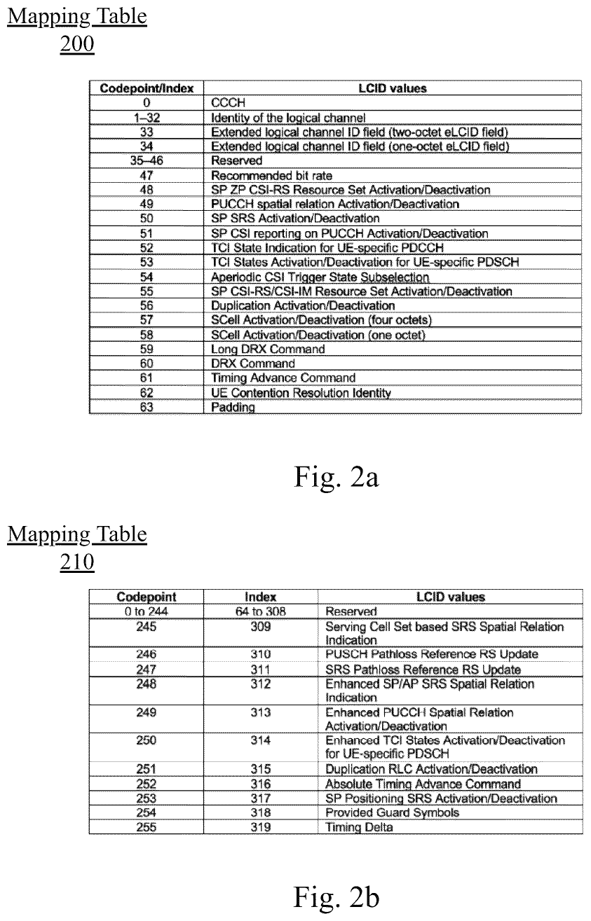

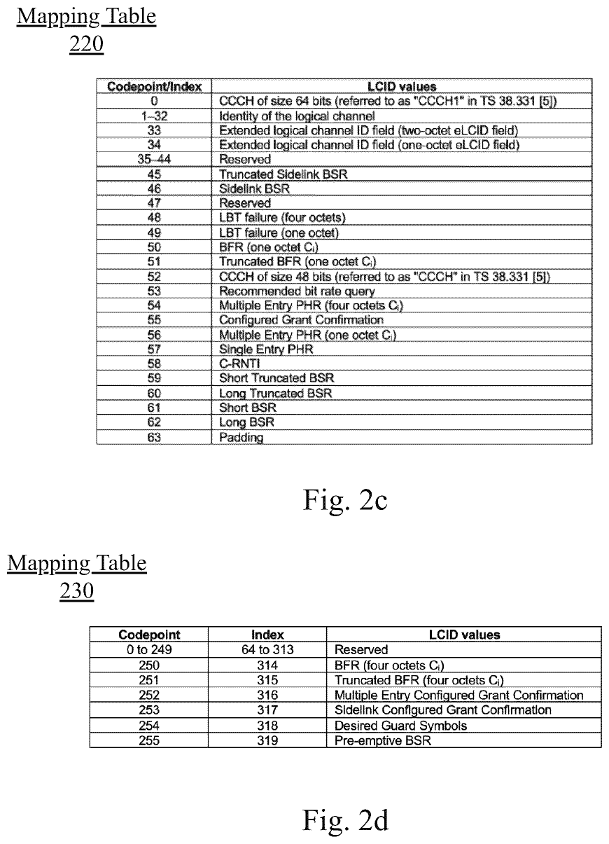

FIG. 2a shows an exemplary mapping table 200 of logical channel ID (LCID) field codepoints to LCID values for the downlink (DL) (e.g., for the DL-SCH transport channel) according to existing specification. The 6-bit LCID field in the MAC sub-header can indicate 64 different codepoints (0-63). For example, a codepoint of 0 indicates the common control channel (CCCH) and the codepoints 1-32 indicate a logical channel identity. A particular LCID value (e.g., LCID=33) is used to indicate that the sub-header format including the 8-bit (one octet) eLCID field is used.

FIG. 2b shows an exemplary mapping table 210 of extended logical channel ID (eLCID) field codepoints to LCID values for the downlink (DL) (e.g., for the DL-SCH transport channel) according to existing specification. The 8-bit eLCID field in the MAC sub-header can indicate 256 different codepoints (0-255). These eLCID codepoints map to LCID index range 64-319. For example, the codepoints 0-244 indicate LCID index values 64-308 and are reserved and the codepoints 245-255 indicate LCID index values 309-319 and correspond to various DL MAC CEs.

FIG. 2c shows an exemplary mapping table 220 of logical channel ID (LCID) field codepoints to LCID values for the uplink (UL) (e.g., for the UL-SCH transport channel) according to existing specification. The 6-bit LCID field in the MAC sub-header can indicate 64 different codepoints (0-63). Similar to the DL-SCH, a particular LCID value (e.g., LCID=33) is used to indicate that the sub-header format including the 8-bit (one octet) eLCID field is used. FIG. 2d shows an exemplary mapping table 230 of extended logical channel ID (eLCID) field codepoints to LCID values for the uplink (UL) (e.g., for the UL-SCH transport channel) according to existing specification. Similar to the DL-SCH, the 8-bit eLCID field in the MAC sub-header can indicate 256 different codepoints (0-255) that map to LCID index range 64-319. For example, the codepoints 0-249 indicate LCID index values 64-313 and are reserved and the codepoints 250-255 indicate LCID index values 314-319 and correspond to various UL MAC CEs.

As shown above, the MAC sub-header format without the eLCID field can indicate an LCID index value of 0-63 (set1), and the MAC sub-header format including the one-octet eLCID field can indicate the LCID index value of 0-63 (set1) and further LCID index value of 64-308 (set2). The set1 in the first octet can be processed by the MAC layer more quickly than the set2 in the second octet. The general principle followed during 5G NR development is that less frequent and low priority MAC CEs should be assigned to set2, and more frequent and high priority MAC CEs (which also require low overhead) can be assigned to set1. No restriction (e.g., always to have L field) is needed to assign a new MAC CE to set2. In Rel-17, it was confirmed that coverage limited cases shall use the set1 values (LCID values 0-63) and other cases shall use the set2 values (eLCID values 0-255 corresponding to LCID values 64-319). The logical channel prioritization (LCP) priority may need to be corrected to achieve consistency.

A number of new MAC CEs have been or will be introduced in Rel-17. To identify a logical channel for the new MAC CEs, the number of logical channel identifiers (LCIDs) currently available in TS 38.321 is not sufficient. However, there are more than enough extended LCIDs (eLCIDs) available from reserved codepoints. Thus, similar to Rel-16, it is likely that the one-octet eLCID space will be used for new MAC CEs. For various reasons, the more frequently used MAC CEs may be best allocated in the LCID space.

In future releases, new 3GPP functions will lead to additional MAC CEs. Additionally, more control functions may move from RRC to MAC and cause still further MAC CEs to be specified. Thus, the current LCID design may need to be reformed. It has been proposed that the network can allocate and move around (by network configuration) some of the MAC CEs to certain positions in the LCID or eLCID space.

According to various exemplary embodiments described herein, several options are proposed for the grouping and allocation of MAC CEs to Logical Channel IDs (LCIDs). Depending on the specific LCID space and the place in the LCID space selected to signal a particular MAC CE, certain MAC CEs may need fewer bytes to signal, whereas other MAC CEs can afford more bytes. By optimizing the allocation of MAC CEs to an LCID space, certain MAC CEs may require fewer header bytes for transmission and/or enable a faster processing path.

According to some aspects of the present disclosure, the sub-grouping of MAC CEs is described. Various approaches can be considered to make the LCID space more scalable by categorizing MAC CEs into groups based on the following considerations. The following options can be used alone or may be combined as appropriate.

In a first option, the MAC CEs are categorized based on the function of the MAC CE. For example, MAC CEs can be categorized based on sub-functions within L1 Control, L2, or Upper Layer. In a second option, the MAC CEs are categorized based on processing/latency (e.g., timeline or deadline) requirements. For example, MAC CEs requiring low latency may be grouped separately from MAC CEs not requiring low latency. In a third option, the MAC CEs are categorized based on LCP/priority. As described above, the LCP refers to a prioritization of MAC CEs or logical channels for filling a MAC PDU.

In a fourth option, the MAC CEs are categorized based on a hierarchical indication, e.g., a feature indicator and sub-feature indicator. For example, 3GPP organizes the functions of different work items (WI) in features and feature groups. Different features can be identified by a feature indicator or a sub-feature indicator defined in the specification. For example, the UE feature list, which is described in TR 38.822, defines a mapping. Feature groups are further associated via the RRC protocol. New MAC CEs are often defined in accordance with a specific feature or sub-feature of a WI. If the UE does not support a certain set of features or sub-features then the respective space in the LCID table can be used for something else (e.g., for other MAC CEs of a feature that the UE supports). Since the UE indicates the set of features that it supports to the network (while other features are also mandatory or always assumed to be active depending on the procedure), the network can use this knowledge of UE features to categorize or organize the allocation of MAC CEs, LCIDs, or MAC CE priorities (during LCP) according to features or sub-features.

In a fifth option, the MAC CEs are categorized based on a 3GPP release indication, e.g., root and release.

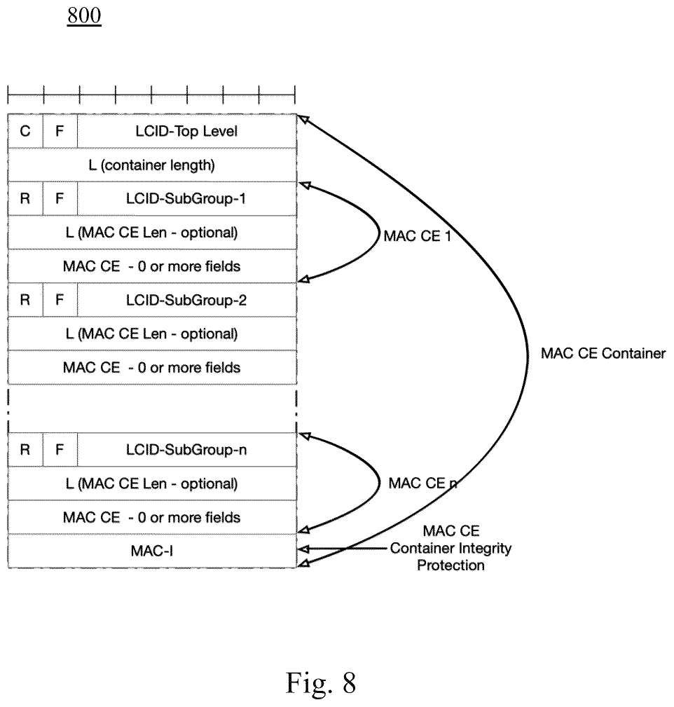

Various options can be considered to identify one of these groups or sub-groups in the MAC sub-header. In one option, one or more top level LCIDs (e.g., from among the LCID values 0-63 indicated in the LCID field) can be allocated that can be shared by multiple sub-identifiers within a MAC CE Container or within an eLCID group. The MAC CE Container can be identified with the top level LCID value by a fast path (e.g., real time) component and later processed by software (e.g., non-real-time components) to identify the sub-identifier for the particular MAC CE. A MAC CE container may consist of one “common” LCID which identifies a group of MAC CEs, and the payload of this MAC CE contains a header to further demultiplex the messages according to their function (e.g., for the actual destination of the MAC CE) in a second step. There may be one or multiple MAC CEs in a MAC CE container. Each individual MAC CE in the group can be identified by an ID. The makeup of a particular MAC CE container can be based on the categorization options discussed above. The top level container may be created so that all MAC CEs relevant to a common modem component, e.g., PHY Tx processing, may be categorized. The top level LCID can also be used by the modem receiver fast path (real time path) to route the MAC CE container to a different destination. The MAC CE container may also be used to provide additional security, via ciphering and integrity protection to the MAC CEs. Ciphering is applied only to the MAC CE content and not to the top level MAC CE container header. One or more bytes of MACI may be appended to each container. FIG. 8 shows an exemplary MAC CE container 800 according to various exemplary embodiments.

In another option, a top level LCID can be allocated that is shared by multiple sub-identifiers by serving as a pointer to an eLCID group. For example, in current specification, the LCID value 33 or 34 indicates that the eLCID is used. In the presently described option, additional LCID values can point to a specific range of eLCID values.

The allocation of a top level LCID (set1 LCID) for a MAC CE or a group of MAC CEs, which can be indicated without using the one-octet eLCID MAC sub-header, can be considered a “fast path” for processing the LCID. That is, the MAC entity (at the UE or gNB) receiving the transmission can quickly identify the final destination of the MAC CE, without identifying the specific MAC CE that is included in the transmission, in view of the reduced search space relative to searching the eLCID space. These options comprise a two-step approach, where the LCID value allows the MAC entity to process a first aspect of the transmission quickly and process a second aspect of the transmission (identify the specific sub-identifier within the MAC CE container or eLCID group) later.

If a particular type of MAC CE is time sensitive, then this MAC CE can be allocated directly in the LCID space (one step approach).

In view of the framework described above, MAC CEs can be allocated into different groups or sub-groups based on function, time sensitivity, priority, etc., and processed quickly, slowly, and/or more efficiently based on the RAN requirements attendant to the MAC CE.

According to another aspect of these exemplary embodiments, a framework for reconfiguring or remapping MAC CEs to different groups or sub-groups within an LCID or an eLCID is described. The specific mechanisms for reconfiguring/remapping MAC CEs are described in greater detail further below.

In one approach, the LCID space may remain fixed or not reconfigurable, such that this LCID space is used for critical and/or coverage related MAC CEs only. That is, a reconfiguration may target the sub-space mapping (e.g., the grouping of eLCIDs) instead of the main LCID space. The set1 LCID space can be considered fixed and the set2 LCID space (or MAC CE container) can be variable (subgroups in set2->2.1, 2.2 . . . 2.n). In another approach, at least some critical MAC CEs in set1 are not reconfigurable to ensure the most basic operation of a communication between gNB and UE (e.g., MAC CEs transmitted during a random access procedure).

Following a reconfiguration, upon MAC CE or LCID/eLICD remapping, the MAC entity needs to be reset (i.e., a MAC reset is to be done). Moreover, a RLC or PDCP re-establishment may be needed in certain cases. From an implementation complexity point of view, hierarchical (or deeply nested) sub-grouping of MAC CEs is less preferred, especially in higher throughput scenarios. Currently, there are no high-throughput scenarios contemplated for MAC CEs. However, the frequent exchange of MAC CEs may soon become more prevalent in upcoming releases, e.g., MAC CEs for FR2/beamforming, TCI state, etc. An overhead reduction would have a more significant effect in these cases.

According to another aspect of these exemplary embodiments, the “R” field in the MAC sub-header can be repurposed to define two sets of LCIDs. For example, when R=0, the currently specified LCID/eLCID tables, as shown in FIGS. 2a-d, can be used, and when R=1, an alternative LCID or eLCID table can be used. The alternative LCID table(s) can be defined in specification, similar to the existing LCID table(s).

In one option, the alternative LCID table(s) can comprise a structure similar to the existing LCID table(s). That is, in this option, the LCID/eLCID space is extended by doubling the number of available LCIDs. In another option, the alternative LCID table(s) can comprise a compressed structure relative to the existing LCID table(s). The compressed table(s) can allocate a reduced number of LCIDs to MAC CEs so that, in this option, the LCID/eLCID space is extended but can be searched more quickly than the existing LCID/eLCID space.

The use of the “R” bit, as described above, can be configured for a UE via RRC signaling.

In another option, the network may modify the alternative or compressed LCIDs tables via RRC signaling. For example, completely new LCID tables may be sent or the content of certain LCID entries may be updated. Alternatively, the mapping/sub-grouping may be changed. In a further extension, the UE may be provided with a pre-configuration of several alternative mappings whereby each pre-configuration is associated with an ID. Network signaling can later refer to this ID in order to switch the mapping or even enable additional LCID tables.

In still another aspect of these exemplary embodiments, a group ID can be indicated that points to a certain position in eLCID space. For example, each group ID can identify a (fixed) amount of 2^{x} LCIDs out of the 2⁶=256 available LCIDs in the eLCID space. The superscript x can be associated to the respective group IDs so that the amount of eLCIDs in each group can vary. For example, a first LCID group can include 2³=8 LCIDs and a second LCID group can include 2⁴=16 LCIDs. In an alternative embodiment, certain group IDs may link to the eLCID space and certain other group IDs may link to the LCID space.

In one embodiment, a new MAC sub-header format can be defined that includes a group ID field. In one example, the group ID field can comprise 2-bits that are repurposed from the LCID field, and a shortened LCID (sLCID) field comprising 4-bits can be used. In some embodiments, the new MAC sub-header format can be enabled by RRC signaling, or can be indicated in the new MAC sub-header by repurposing the “R” bit.

In one embodiment, the new MAC sub-header format can be bundled with RACH (sub-feature indication and partitioning) or broadcast indication for a mapping. In Rel-17, a method for “RACH indication and partitioning” was introduced which allows for the association of a set of random access resources to a feature or sub-feature (such as small data transmission (SDT), coverage enhancement, RAN slicing, reduced capability (RedCap), etc.). In this context, the network can associate a set of random access resources with specific feature(s) triggering the Random Access procedure. A set of random access resources associated with a feature is only valid for random access procedures for that feature; and a set of random access resources associated with several features is only valid for random access procedures having all these features. Thus, in this embodiment, the new MAC sub-header format can be associated with a set of RACH resources.

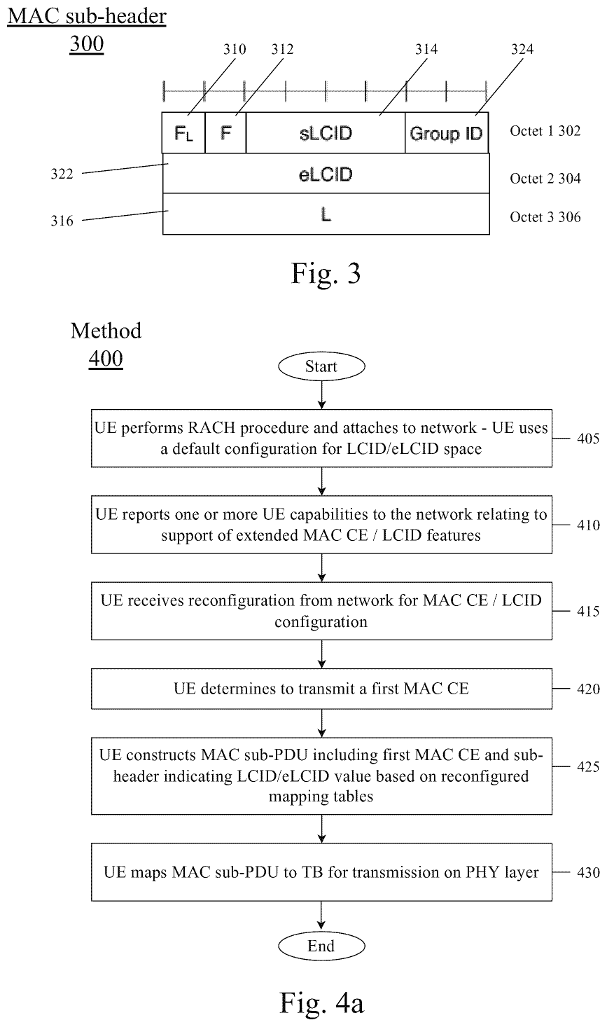

FIG. 3 shows an exemplary MAC sub-header 300 including a group ID field 324 according to various exemplary embodiments. In this example, a first octet 302 includes a first format field F_{L} 310 (1 bit), a second format field F 312 (1 bit), a shortened LCID (sLCID) field 314 (4 bits), and a group ID field 324 (2 bits). A second octet 304 includes an extended LCID (eLCID) field 322 (8 bits) and a third octet 306 includes a length field L 316 (8 bits). The F field 312, the eLCID field 322 and the L field 316 can be formatted similarly to the F field 112, the eLCID field 122 and the L field 116 shown in the MAC sub-header 120 of FIG. 1b. The FL field 310 can be repurposed from the R field 110 to indicate the new MAC sub-header format 300 is used and the group ID field 324 can be repurposed from the LCID field 114 of the MAC sub-header 120 of FIG. 1b. The sLCID field 314 (4 bits) is shortened relative to the LCID field 114 (6 bits) of the MAC sub-header 120 of FIG. 1b.

If the new MAC sub-header 300 is used, one disadvantage is that most essential LCIDs and logical channels would no longer fit into the first octet 302, as the number of possible LCID values indicated in the sLCID field 314 would be reduced from 64 to 16 LCIDs. In an alternative embodiment, the unmodified MAC sub-header 120 of FIG. 1b can be used, and the group ID could be signaled in some other manner, e.g., dedicated RRC signaling. In another alternative, the unmodified MAC sub-header 120 of FIG. 1b can be used, and a top level (set1) LCID can point to a set of LCIDs in the eLCID space. This can enable sub-groups of eLCIDs that can be defined in a table. For example, LCID 35 can point to eLCID group 1, LCID 36 can point to eLCID group 2, etc.

Based on the group ID, the receiving MAC entity can quickly process and identify some aspects of the MAC CE (e.g., features of the MAC CE inherent to the MAC CEs within the group) and handle the MAC CE accordingly. For example, a MAC CE from a group of time-sensitive MAC CEs can be quickly processed, while a MAC CE from a group of non-time-sensitive MAC CEs can be processed later.

According to another aspect of these exemplary embodiments, various options are described for accommodating multiple MAC CE tables, or different layouts/groups, where each layout/group points to a specific structure or allocation of MAC CEs as described above. The UE can store one or multiple MAC CE/LCID mappings. In some embodiments, an identifier for one of the multiple available configurations can be indicated in a reconfiguration from the network.

In a first aspect, the MAC CE configuration (or multiple MAC CE configurations), including sets of MAC CEs and their allocations, can be defined in specification. There may be different ways to allocate, map and distribute the MAC CEs over, e.g., the LCID and eLCID specifications. If multiple configurations are specified, each such configuration can be linked with an identifier.

In a second aspect, if multiple configurations are specified, the identifier for the MAC CE configuration can be broadcast by the network in SIB. The UE can decode the SIB and determine which MAC CE configuration to use based on the identifier.

In a third aspect, an association can be defined between UE features and MAC CE tables. For example, a set of sub-features possessed by the UE can link with a predefined allocation of MAC CEs to Logical Channel IDs (LCID/eLCID tables). A UE supporting a specific feature or a specific set of multiple features can use one of the predefined configurations. The mapping can be defined in specification for both UE capabilities (e.g., TS 38.306 in 5G) and MAC CEs (e.g., TS 38.321 in 5G).

In addition, a default MAC CE/LCID mapping can be defined. The default mapping can be used until full UE capabilities are known to the network. Also, in case of an error (e.g., decoding error, etc.), the default mapping can be used as a fallback.

In a fourth aspect, the MAC CE mapping can be configured/reconfigured as part of a normal RRC reconfiguration (dedicated signaling, for example, using the configuration identifier).

In a fifth aspect, a new downlink MAC CE can be defined to configure/reconfigure the LCID space. In this aspect, the UE may acknowledge the MAC CE reconfiguration with an uplink MAC CE in response.

In a sixth aspect, a new DCI field may be used to dynamically trigger a reallocation of MAC CEs for a specific duration of time.

In a seventh aspect, a new DCI field may be used to dynamically trigger a reallocation of MAC CEs for only a specific set of features.

In an eighth aspect, for either the sixth or seventh aspects discussed above where a new DCI field is used to trigger a reallocation of MAC CEs, the UE can respond with a MAC CE in the uplink (UL).

In a ninth aspect, more generally, a reallocation of MAC CE mappings (e.g., by promoting one or multiple MAC CEs from set 2 to set1, or to a different, more prominent position in the table) can be applicable to a smaller subset of MAC CEs only. The subset may only relate to MAC CEs linked with a specific sub-feature. The subset may only relate to selected MAC CEs (for example, certain MAC CEs that may appear more frequently than others). Likewise, the reallocation may apply for a limited time only (via a timer). Or, the reallocation may apply to the complete table of all MAC CEs.

In further aspects of these exemplary embodiments, one or more UE capabilities may be required to indicate UE support of multiple LCID tables, reconfigurable LCID tables, etc., to, e.g., ensure backward compatibility as needed. In one option, a UE capability can enable a subsequent one or more respective RRC configurations. Additionally, an explicit RRC parameter may be required as well for configuring/reconfiguring the UE with a particular LCID structure. If the aforementioned MAC CE extension approaches are applied to future 5G releases or future generations (6G), the MAC CE extension could be considered mandatory for all UEs supporting the future release to reduce gNB complexity.

Additionally, as part of the MAC logical channel prioritization procedure, logical channels can be prioritised in accordance with a priority order, which also encompasses the selection of MAC CEs eligible for inclusion in a MAC PDU following a grant. In this context, the processing order of MAC CEs itself (e.g., the prioritization order or MAC CEs/data), which is currently fixed at the end of sub-clause 5.4.3.1.3 in TS 38.321, can be made configurable or reconfigurable by the network where the prioritization of MAC CEs may follow similar sub-grouping principles as indicated above.

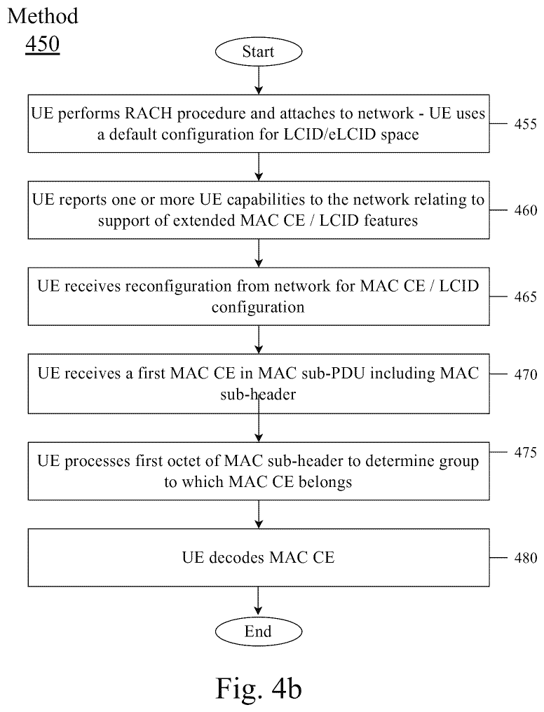

FIG. 4a shows a method 400 for MAC CE transmission according to various exemplary embodiments. The method 400 is described from the perspective of a user equipment (UE) transmitting a MAC CE to a base station. It should be understood that certain aspects of the method 400, specifically regarding the construction and transmission of the MAC CE by the UE on the uplink (UL), can be performed similarly by a base station (e.g., gNB) constructing and transmitting a MAC CE to the UE on the downlink (DL).

In the method 400, the UE supports one or more extensions of the existing MAC CE/LCID design. For example, as described in the exemplary aspects above, the UE can support a MAC CE/LCID framework in which multiple MAC CEs are categorized into groups based on one or more features common to the grouped MAC CEs; specified LCID/eLCID tables mapping LCID/eLCID codepoints to multiple MAC CEs in a fixed or variable LCID/eLCID space; multiple available configurations for either one or both of the LCID space and the eLCID space that are configurable/reconfigurable by the network; a new MAC sub-header format including a group ID field; and other features. As described above, these various features can be used alone or, in some embodiments, in combination. The MAC CEs can be grouped according to various features common to the grouped MAC CEs.

Additionally, in the method 400, the UE is reconfigurable between different specified LCID/MAC CE tables/spaces. However, in other embodiments, the UE has a fixed LCID/MAC CE space.

In 405, the UE performs a random access (RACH) procedure and attaches to a network, e.g., the 5G NR RAN. During the initial access procedure, and prior to receiving any dedicated configurations/reconfigurations from the network, the UE MAC layer can use a default configuration for LCID/eLCID.

In one embodiment, the default LCID/eLCID configuration can correspond to the existing framework specified in TS 38.321. In other embodiments, the default LCID/eLCID configuration can include sub-groupings of MAC CEs that are identified by a single LCID and/or eLCID value. These sub-groupings can be categorized in a number of ways, including 1) based on function; 2) based on timeline/latency; 3) based on LCP/priority; 4) based on a hierarchical indication; and/or 5) based on a 3GPP release.

The UE can select the default configuration from multiple available LCID/eLCID configurations/tables defined in UE specification, each configuration associated with an identifier, or the UE can be designed with only a single configuration option. The configuration can be selected by the UE from multiple configurations defined in specification based on a set of sub-features supported by the UE.

In 410, the UE reports one or more UE capabilities to the network. The UE capabilities can relate to support of the various MAC CE/LCID features discussed above.

In 415, the UE receives a reconfiguration from the network for a different MAC CE/LCID configuration. The reconfiguration (e.g., the identifier) can be broadcast in SIB; received in an RRC reconfiguration; received in a new DL MAC CE; or received in a new DCI field. The reconfigured MAC CE/LCID configuration can be used by the UE until a subsequent reconfiguration, or the reconfiguration can be applicable for a predetermined duration before reverting to the default configuration. When the reconfiguration is received, the MAC entity of the UE is reset. Additionally, in some embodiments, the UE can send an acknowledgment of the reconfiguration to the network

In 420, the UE determines to transmit a first MAC CE to the network for any of a variety of reasons.

In 425, the UE constructs a MAC sub protocol data unit (sub-PDU) including a MAC sub-header and a payload including the first MAC CE. The MAC sub-PDU is constructed based on the reconfigured LCID/MAC CE space from 415. For example, the LCID value can indicate a MAC CE directly, a MAC CE container, a group of eCLIDs, etc. An additional layer of nesting can be used, where an eLCID can indicate a further group of eLCIDs. In this example, in the MAC sub-header, the UE indicates a LCID value associated with the first MAC CE, the LCID value identifying a first group of MAC CEs categorized based on a feature, e.g., function or priority. In some embodiments, the MAC sub-header format may correspond to existing specification while in other embodiments the MAC sub-header may comprise a new format that includes, e.g., a group ID field and/or an R field repurposed to indicate one of two available LCID/MAC CE configurations.

In 430, the UE maps the MAC sub-PDU to a transport block (TB) for transmission on the PHY layer.

FIG. 4b shows a method 450 for MAC CE reception according to various exemplary embodiments. The method 450 is described from the perspective of a user equipment (UE) receiving a MAC CE from a base station. It should be understood that certain aspects of the method 450, specifically regarding the reception and processing of the MAC CE by the UE on the downlink (DL), can be performed similarly by a base station (e.g., gNB) receiving and processing a MAC CE from the UE on the uplink (UL).

Similar to the method 400, in the method 450, the UE supports one or more extensions of the existing MAC CE/LCID design. As described above, these various features related to the MAC CE/LCID space can be used alone or, in some embodiments, in combination. Additionally, similar to the method 400, in the method 450, the UE is reconfigurable between different specified LCID/MAC CE tables/spaces. However, in other embodiments, the UE has a fixed LCID/MAC CE space. Steps 455-465 of the method 450 may be substantially similar to the steps 405-415 of the method 400.

In 470, the UE receives a first MAC CE from the network for any of a variety of reasons. The first MAC CE is the payload of a MAC sub-PDU constructed with a MAC sub-header. In some embodiments, the received MAC sub-header can have a format similar to existing specification while in other embodiments the MAC sub-header may comprise a new format. The MAC sub-header indicates a LCID value in the first octet.

In 475, the UE processes the first octet of the MAC sub-header to determine, from the LCID value, a group to which the MAC CE belongs. For example, the LCID value can map to a range of eLCID values, etc. From the LCID value, the UE can determine whether the MAC CE is time-sensitive or not.

In 480, the UE decodes the MAC CE.

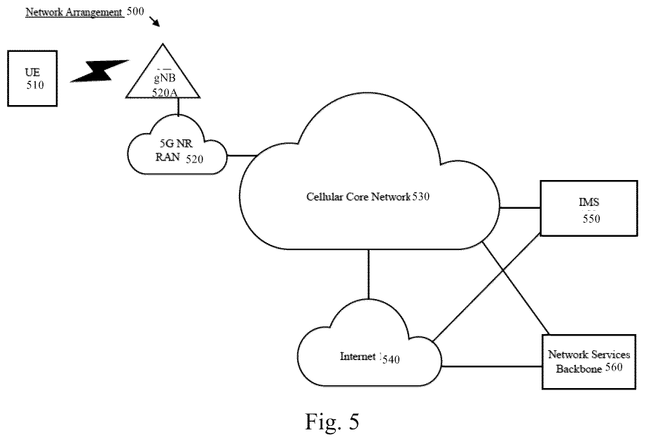

FIG. 5 shows an exemplary network arrangement 500 according to various exemplary embodiments. The exemplary network arrangement 500 includes a UE 510. Those skilled in the art will understand that the UE 510 may be any type of electronic component that is configured to communicate via a network, e.g., mobile phones, tablet computers, desktop computers, smartphones, phablets, embedded devices, wearables (e.g., HMD, AR glasses, etc.), Internet of Things (IoT) devices, etc. It should also be understood that an actual network arrangement may include any number of UEs being used by any number of users. Thus, the example of a single UE 510 is merely provided for illustrative purposes.

The UE 510 may be configured to communicate with one or more networks. In the example of the network configuration 500, the network with which the UE 510 may wirelessly communicate is a 5G NR radio access network (RAN) 520. However, the UE 510 may also communicate with other types of networks (e.g., 5G cloud RAN, a next generation RAN (NG-RAN), a long term evolution (LTE) RAN, a legacy cellular network, a WLAN, etc.) and the UE 510 may also communicate with networks over a wired connection. With regard to the exemplary embodiments, the UE 510 may establish a connection with the 5G NR RAN 520. Therefore, the UE 510 may have a 5G NR chipset to communicate with the NR RAN 520.

The 5G NR RAN 520 may be a portion of a cellular network that may be deployed by a network carrier (e.g., Verizon, AT&T, T-Mobile, etc.). The 5G NR RAN 520 may include, for example, cells or base stations (Node Bs, eNodeBs, HeNBs, eNBS, gNBs, gNodeBs, macrocells, microcells, small cells, IAB nodes, femtocells, next generation nodes (e.g., 6G), etc.) that are configured to send and receive traffic from UEs that are equipped with the appropriate cellular chip set.

The UE 510 may connect to the 5G NR-RAN 520 via the gNB 520A. Those skilled in the art will understand that any association procedure may be performed for the UE 510 to connect to the 5G NR-RAN 520. For example, as discussed above, the 5G NR-RAN 520 may be associated with a particular cellular provider where the UE 510 and/or the user thereof has a contract and credential information (e.g., stored on a SIM card). Upon detecting the presence of the 5G NR-RAN 520, the UE 510 may transmit the corresponding credential information to associate with the 5G NR-RAN 520. More specifically, the UE 510 may associate with a specific base station (e.g., gNB 520A). However, as mentioned above, reference to the 5G NR-RAN 520 is merely for illustrative purposes and any appropriate type of RAN may be used.

The network arrangement 500 also includes a cellular core network 530, the Internet 540, an IP Multimedia Subsystem (IMS) 550, and a network services backbone 560. The cellular core network 530 may be considered to be the interconnected set of components that manages the operation and traffic of the cellular network. The cellular core network 530 also manages the traffic that flows between the cellular network and the Internet 540. The IMS 550 may be generally described as an architecture for delivering multimedia services to the UE 510 using the IP protocol. The IMS 550 may communicate with the cellular core network 530 and the Internet 540 to provide the multimedia services to the UE 510. The network services backbone 560 is in communication either directly or indirectly with the Internet 540 and the cellular core network 530. The network services backbone 560 may be generally described as a set of components (e.g., servers, network storage arrangements, etc.) that implement a suite of services that may be used to extend the functionalities of the UE 510 in communication with the various networks.

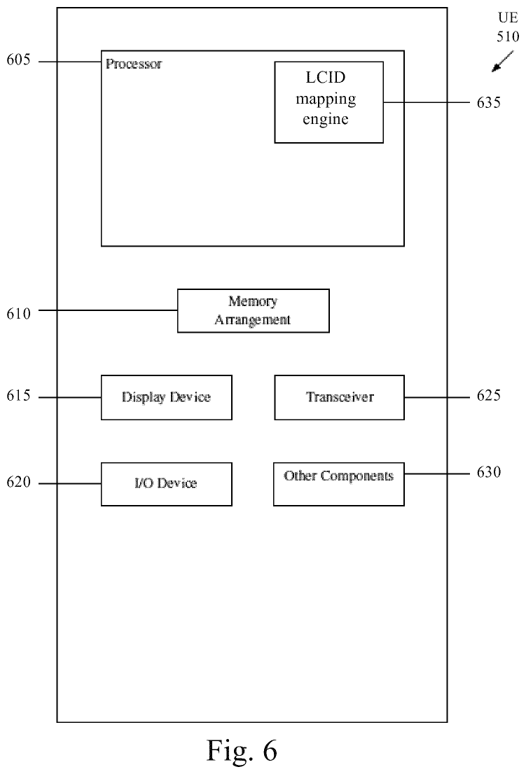

FIG. 6 shows an exemplary UE 510 according to various exemplary embodiments. The UE 510 will be described with regard to the network arrangement 500 of FIG. 5. The UE 510 may include a processor 605, a memory arrangement 610, a display device 615, an input/output (I/O) device 620, a transceiver 625 and other components 630. The other components 630 may include, for example, an audio input device, an audio output device, a power supply, a data acquisition device, ports to electrically connect the UE 510 to other electronic devices, etc.

The processor 605 may be configured to execute a plurality of engines of the UE 510. For example, the engines may include an LCID mapping engine 635 for performing various operations related to transmitting/receiving MAC CEs in the above described framework. The above referenced engine 235 being an application (e.g., a program) executed by the processor 605 is provided merely for illustrative purposes. The functionality associated with the engine 635 may also be represented as a separate incorporated component of the UE 510 or may be a modular component coupled to the UE 510, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 605 is split among two or more processors such as a baseband processor and an applications processor. The exemplary embodiments may be implemented in any of these or other configurations of a UE.

The memory arrangement 610 may be a hardware component configured to store data related to operations performed by the UE 510. The display device 615 may be a hardware component configured to show data to a user while the I/O device 620 may be a hardware component that enables the user to enter inputs. The display device 615 and the I/O device 620 may be separate components or integrated together such as a touchscreen. The transceiver 625 may be a hardware component configured to establish a connection with the 5G NR-RAN 520 and/or any other appropriate type of network. Accordingly, the transceiver 625 may operate on a variety of different frequencies or channels (e.g., set of consecutive frequencies).

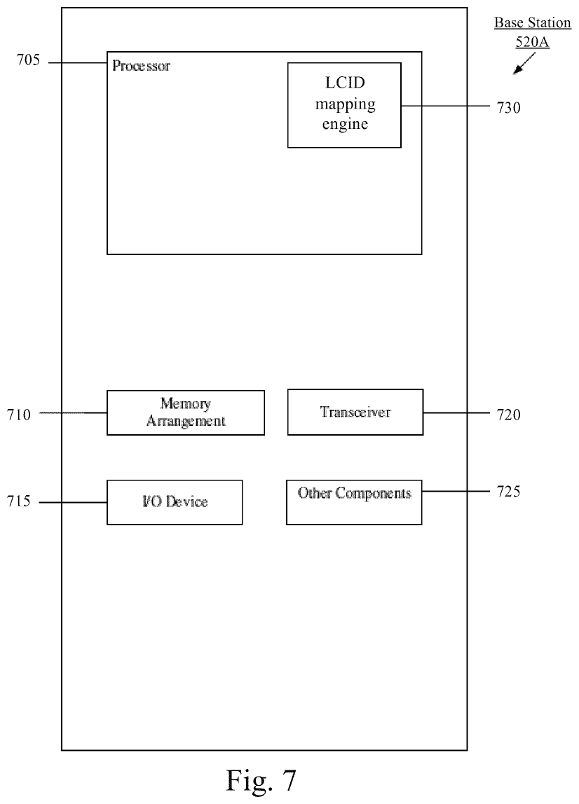

FIG. 7 shows an exemplary base station 520A according to various exemplary embodiments. The base station 520A may represent any access node through which the UE 510 may establish a connection and manage network operations.

The base station 520A may include a processor 705, a memory arrangement 710, an input/output (I/O) device 715, a transceiver 720, and other components 725. The other components 725 may include, for example, a battery, a data acquisition device, ports to electrically connect the base station 700 to other electronic devices, etc.

The processor 705 may be configured to execute a plurality of engines of the base station 520A. For example, the engines may include an LCID mapping engine 730 for performing various operations related to transmitting/receiving MAC CEs in the above described framework. The above noted engine 730 being an application (e.g., a program) executed by the processor 705 is only exemplary. The functionality associated with the engine 730 may also be represented as a separate incorporated component of the base station 700 or may be a modular component coupled to the base station 700, e.g., an integrated circuit with or without firmware. For example, the integrated circuit may include input circuitry to receive signals and processing circuitry to process the signals and other information. In addition, in some base stations, the functionality described for the processor 705 is split among a plurality of processors (e.g., a baseband processor, an applications processor, etc.). The exemplary embodiments may be implemented in any of these or other configurations of a base station.

The memory 710 may be a hardware component configured to store data related to operations performed by the base station 700. The I/O device 715 may be a hardware component or ports that enable a user to interact with the base station 700. The transceiver 720 may be a hardware component configured to exchange data with the UE 510 and any other UE in the system 500. The transceiver 720 may operate on a variety of different frequencies or channels (e.g., set of consecutive frequencies). Therefore, the transceiver 720 may include one or more components (e.g., radios) to enable the data exchange with the various networks and UEs.

### EXAMPLES

In a first example, a medium access control (MAC) layer instance configured to perform operations comprising receiving a first MAC control element (MAC CE) within a MAC sub protocol data unit (sub-PDU) including a MAC sub-header and a payload including the first MAC CE, identifying, in a first octet of the MAC sub-header, a logical channel identifier (LCID) value that identifies a first group of MAC CEs categorized based on a feature, the first group of MAC CEs including the first MAC CE and decoding the first MAC CE.

In a second example, the MAC layer instance of the first example, wherein the feature used to categorize the first group of MAC CEs comprises a function for the MAC CEs within the first group.

In a third example, the MAC layer instance of the second example, wherein the function comprises a sub-function within layer 1 (L1) control, layer 2 (L2), or upper layers.

In a fourth example, the MAC layer instance of the first example, wherein the feature used to categorize the first group of MAC CEs comprises latency requirements for the MAC CEs within the first group.

In a fifth example, the MAC layer instance of the first example, wherein the feature used to categorize the first group of MAC CEs comprises a logical channel prioritization (LCP) for the MAC CEs within the first group.

In a sixth example, the MAC layer instance of the first example, wherein the feature used to categorize the first group of MAC CEs comprises a feature group or support of a specific combination of features or sub-features for the MAC CEs within the first group.

In a seventh example, the MAC layer instance of the first example, wherein the feature used to categorize the first group of MAC CEs comprises a 3GPP release indication for the MAC CEs within the first group.

In an eighth example, the MAC layer instance of the first example, wherein the first group of MAC CEs are included within a MAC CE container.

In a ninth example, the MAC layer instance of the eighth example, wherein the MAC CE container is identified with a top level LCID value that is processed by a fast path modem component, wherein a payload of the MAC CE container includes a header to further process the MAC CE according to its function.

In a tenth example, the MAC layer instance of the first example, wherein the first group of MAC CEs are included within an extended LCID (eLCID) group.

In an eleventh example, a medium access control (MAC) layer instance is configured to perform operations comprising receiving a first MAC control element (MAC CE) within a MAC sub protocol data unit (sub-PDU) including a MAC sub-header and a payload including the first MAC CE, identifying, in a first octet of the MAC sub-header, a value of a Reserved (R) bit that identifies a first set of logical channel identifier (LCID) tables or a second set of LCID tables used to determine a logical channel or MAC CE identity from an LCID value included in the MAC sub-header and decoding the first MAC CE based on the first or second set of LCID tables identified from the R bit.

In a twelfth example, the MAC layer instance of the eleventh example, wherein, when R=0, the first set of LCID tables is used and, when R=1, the second set of LCID tables is used.

In a thirteenth example, the MAC layer instance of the twelfth example, wherein the first and second sets of LCID tables comprise a same range of LCID values.

In a fourteenth example, the MAC layer instance of the twelfth example, wherein the second set of LCID tables is compressed relative to the first set of LCID tables.

In a fifteenth example, the MAC layer instance of the fourteenth example, wherein a second set of extended LCID (eLCID) tables is compressed relative to a first set of eLCID tables.

In a sixteenth example, the MAC layer instance of the eleventh example, wherein, when the MAC layer instance operates at a user equipment (UE), the operations further comprise receiving a radio resource control (RRC) configuration enabling the use of the R bit.

In a seventeenth example, the MAC layer instance of the eleventh example, wherein, when the MAC layer instance operates at a user equipment (UE), the operations further comprise receiving one or more modified sets of LCID tables via radio resource control (RRC) signaling.

In an eighteenth example, the MAC layer instance of the eleventh example, wherein, when the MAC layer instance operates at a user equipment (UE), the UE is pre-configured with alternative LCID table mappings, wherein each of the pre-configurations is associated with an identifier, wherein the operations further comprise receiving an identifier for one of the pre-configurations via radio resource control (RRC) signaling.

In a nineteenth example, the MAC layer instance of the eleventh example, wherein, when the MAC layer instance operates at a base station, the operations further comprise transmitting a radio resource control (RRC) configuration enabling the use of the R bit.

In a twentieth example, the MAC layer instance of the eleventh example, wherein, when the MAC layer instance operates at a base station, the operations further comprise transmitting one or more modified sets of LCID tables via radio resource control (RRC) signaling.

In a twenty first example, the MAC layer instance of the eleventh example, wherein, when the MAC layer instance operates at a base station, the operations further comprise transmitting an identifier corresponding to one of a set of pre-configured alternative LCID table mappings via radio resource control (RRC) signaling.

In a twenty second example, a processor of a user equipment (UE) configured to perform operations comprising selecting a default logical channel identifier (LCID) configuration for a MAC sub-header to use to transmit and receive MAC control elements (MAC CE) and MAC service data units (SDU) in MAC sub protocol data units (sub-PDU), wherein the default LCID configuration is selected from multiple available LCID configurations defined in UE specification and linked with a respective identifier and performing an initial access procedure to attach to a network, wherein, at least during the initial access procedure, the default LCID configuration is used.

In a twenty third example, the processor of the twenty second example, wherein the default LCID configuration is selected based on a set of sub-features supported by the UE.

In a twenty fourth example, the processor of the twenty second example, wherein the operations further comprise receiving a reconfiguration from the network to use a different LCID configuration.

In a twenty fifth example, the processor of the twenty fourth example, wherein an identifier for the different LCD configuration is received in a system information block (SIB).

In a twenty sixth example, the processor of the twenty fourth example, wherein the reconfiguration comprises dedicated radio resource control (RRC) signaling.

In a twenty seventh example, the processor of the twenty fourth example, wherein a new downlink (DL) MAC CE or a new downlink control information (DCI) field is used to reconfigure the UE, wherein the operations further comprise transmitting an uplink (UL) MAC CE to acknowledge the reconfiguration.

In a twenty eighth example, the processor of the twenty seventh example, wherein the new DCI field triggers the LCID reconfiguration for a duration of time.

In a twenty ninth example, the processor of the twenty seventh example, wherein the new DCI field triggers the LCID reconfiguration for a specific set of features.

In a thirtieth example, the processor of the twenty fourth example, wherein the reconfiguration comprises moving one or more MAC CEs from an extended LCID (eLCID) space to an LCID space or moving one or more MAC CEs from the LCID space to an eLCID space.

In a thirty first example, the processor of the twenty fourth example, wherein the reconfiguration comprises a reallocation of MAC CEs in an extended LCID (eLCID) space while an LCID space remains fixed and is unconfigurable.

In a thirty second example, the processor of the twenty fourth example, wherein the reconfiguration comprises a reallocation of MAC CEs in an LCID space wherein some LCIDs are reallocated while other LCIDs remain fixed and are unconfigurable.

In a thirty third example, the processor of the twenty second example, wherein the default LCID configuration is used during the initial access procedure and an additional duration after initial access, wherein the additional duration is defined in specification.

In a thirty fourth example, a processor of a base station configured to perform operations comprising determining a default logical channel identifier (LCID) configuration for a MAC sub-header to use to transmit and receive MAC control elements (MAC CE) and MAC service data units (SDU) in MAC sub protocol data units (sub-PDU), wherein the default LCID configuration is selected from multiple available LCID configurations and linked with a respective identifier and performing an initial access procedure with a user equipment (UE), wherein, at least during the initial access procedure, the default LCID configuration is used.

In a thirty fifth example, the processor of the thirty fourth example, wherein the operations further comprise transmitting a reconfiguration to the UE to use a different LCID configuration.

In a thirty sixth example, the processor of the thirty fifth example, wherein an identifier for the different LCD configuration is transmitted in a system information block (SIB).

In a thirty seventh example, the processor of the thirty fifth example, wherein the reconfiguration comprises dedicated radio resource control (RRC) signaling.

In a thirty eighth example, the processor of the thirty fifth example, wherein a new downlink (DL) MAC CE or a new downlink control information (DCI) field is used to reconfigure the UE, wherein the operations further comprise receiving an uplink (UL) MAC CE from the UE to acknowledge the reconfiguration.

In a thirty ninth example, the processor of the thirty eighth example, wherein the new DCI field triggers the LCID reconfiguration for a duration of time.

In a fortieth example, the processor of the thirty eighth example, wherein the new DCI field triggers the LCID reconfiguration for a specific set of features.

In a forty first example, the processor of the thirty fifth example, wherein the reconfiguration comprises moving one or more MAC CEs from an extended LCID (eLCID) space to an LCID space or moving one or more MAC CEs from the LCID space to an eLCID space.

In a forty second example, the processor of the thirty fifth example, wherein the reconfiguration comprises a reallocation of MAC CEs in an extended LCID (eLCID) space while an LCID space remains fixed and is unconfigurable.

In a forty third example, the processor of the thirty fifth example, wherein the reconfiguration comprises a reallocation of MAC CEs in an LCID space wherein some LCIDs are reallocated while other LCIDs remain fixed and are unconfigurable.

In a forty fourth example, the processor of the thirty fourth example, wherein the default LCID configuration is used during the initial access procedure and an additional duration after initial access, wherein the additional duration is defined in specification.

In a forty fifth example, a medium access control (MAC) layer instance configured to perform operations comprising receiving a first MAC control element (MAC CE) within a MAC sub protocol data unit (sub-PDU) including a MAC sub-header and a payload including the first MAC CE identifying, in a first octet of the MAC sub-header, a group identifier (group ID) identifying a first group of MAC CEs in an extended LCID (eLCID) space, the first group of MAC CEs including the first MAC CE and decoding the first MAC CE.

In a forty sixth example, the MAC layer instance of the forty fifth example, wherein each available group ID identifies a fixed number of 2^{x} LCIDs.

In a forty seventh example, the MAC layer instance of the forty fifth example, wherein a number of LCIDs associated with an available group ID can vary across groups.

In a forty eighth example, the MAC layer instance of the forty fifth example, wherein a new MAC sub-header format is enabled based on radio resource control (RRC) signaling or indicated in a Reserved (R) bit in the MAC sub-header.

In a forty ninth example, the MAC layer instance of the forty fifth example, wherein the group ID is repurposed from an LCID field and a size of the LCID field is reduced.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

1. A medium access control (MAC) layer instance configured to perform operations comprising:
determining to transmit a first MAC control element (MAC CE);
constructing a MAC sub protocol data unit (sub-PDU) including a MAC sub-header and a payload including the first MAC CE;
indicating, in the MAC sub-header, a logical channel identifier (LCID) value that identifies a first group of MAC CEs categorized based on a feature, the first group of MAC CEs including the first MAC CE; and
mapping the MAC sub-PDU to a transport block (TB) for transmission on a physical (PHY) layer.

2. The MAC layer instance of claim 1, wherein the feature used to categorize the first group of MAC CEs comprises a function for the MAC CEs within the first group.

3. (canceled)

4. The MAC layer instance of claim 1, wherein the feature used to categorize the first group of MAC CEs comprises latency requirements for the MAC CEs within the first group.

5. The MAC layer instance of claim 1, wherein the feature used to categorize the first group of MAC CEs comprises a logical channel prioritization (LCP) for the MAC CEs within the first group.

6. The MAC layer instance of claim 1, wherein the feature used to categorize the first group of MAC CEs comprises a feature group or support of a specific combination of features or sub-features for the MAC CEs within the first group.

7. The MAC layer instance of claim 1, wherein the feature used to categorize the first group of MAC CEs comprises a 3GPP release indication for the MAC CEs within the first group.

8. The MAC layer instance of claim 1, wherein the first group of MAC CEs are included within a MAC CE container, wherein the MAC CE container is identified with a top level LCID value that is processed by a fast path component, wherein a payload of the MAC CE container includes a header to further process the MAC CE according to its function.

9. (canceled)

10. The MAC layer instance of claim 1, wherein the first group of MAC CEs are included within an extended LCID (eLCID) group.

11. A medium access control (MAC) layer instance configured to perform operations comprising:
determining to transmit a first MAC control element (MAC CE);
constructing a MAC sub protocol data unit (sub-PDU) including a MAC sub-header and a payload including the first MAC CE;
indicating, in the MAC sub-header, a value of a Reserved (R) bit that identifies a first set of logical channel identifier (LCID) tables or a second set of LCID tables used to determine a logical channel or MAC CE identity from an LCID value included in the MAC sub-header; and
mapping the MAC sub-PDU to a transport block (TB) for transmission on a physical (PHY) layer.

12. The MAC layer instance of claim 11, wherein, when R=0, the first set of LCID tables is used and, when R=1, the second set of LCID tables is used.

13-15. (canceled)

16. The MAC layer instance of claim 11, wherein, when the MAC layer instance operates at a user equipment (UE), the operations further comprise:
receiving a radio resource control (RRC) configuration enabling the use of the R bit.

17. The MAC layer instance of claim 11, wherein, when the MAC layer instance operates at a user equipment (UE), the operations further comprise:
receiving one or more modified sets of LCID tables via radio resource control (RRC) signaling.

18. The MAC layer instance of claim 11, wherein, when the MAC layer instance operates at a user equipment (UE), the UE is pre-configured with alternative LCID table mappings, wherein each of the pre-configurations is associated with an identifier, wherein the operations further comprise:
receiving an identifier for one of the pre-configurations via radio resource control (RRC) signaling.

19. The MAC layer instance of claim 11, wherein, when the MAC layer instance operates at a base station, the operations further comprise:
transmitting a radio resource control (RRC) configuration enabling the use of the R bit.

20. The MAC layer instance of claim 11, wherein, when the MAC layer instance operates at a base station, the operations further comprise:
transmitting one or more modified sets of LCID tables via radio resource control (RRC) signaling.

21. The MAC layer instance of claim 11, wherein, when the MAC layer instance operates at a base station, the operations further comprise:
transmitting an identifier corresponding to one of a set of pre-configured alternative LCID table mappings via radio resource control (RRC) signaling.

22. A medium access control (MAC) layer instance configured to perform operations comprising:
determining to transmit a first MAC control element (MAC CE);
constructing a MAC sub protocol data unit (sub-PDU) including a MAC sub-header and a payload including the first MAC CE;
indicating, in the MAC sub-header, a group identifier (group ID) identifying a first group of MAC CEs in an extended LCID (eLCID) space, the first group of MAC CEs including the first MAC CE; and
mapping the MAC sub-PDU to a transport block (TB) for transmission on a physical (PHY) layer.

23. The MAC layer instance of claim 22, wherein each available group ID identifies a fixed number of 2^{x} LCIDs.

24. The MAC layer instance of claim 22, wherein a number of LCIDs associated with an available group ID can vary across groups.

25. The MAC layer instance of claim 22, wherein a new MAC sub-header format is enabled based on radio resource control (RRC) signaling or indicated in a Reserved (R) bit in the MAC sub-header.

26. (canceled)
